(19) United States
(12) Patent Application Publication
(10) Pub. No.: US 2025/0192330 A1
(43) Pub. Date: Jun. 12, 2025

(54) MULTI-TIERED TRACTION BATTERY PACKS WITH SHARED CELL STACK END PLATES

(71) Applicant: FORD GLOBAL TECHNOLOGIES, LLC, Dearborn, MI (US)

(72) Inventors: Derek Timothy Taylor, Waterford, MI (US); Nicholas Braeseker, Novi, MI (US)

(21) Appl. No.: 18/966,869

(22) Filed: Dec. 3, 2024

Related U.S. Application Data
(60) Provisional application No. 63/607,888, filed on Dec. 8, 2023.

(51) Int. Cl. H01M 50/289; H01M 50/209; H01M 50/249; H01M 50/264

(52) U.S. Cl. CPC H01M 50/289; H01M 50/209; H01M 50/249; H01M 50/264; H01M 2220/20

(57) ABSTRACT

Traction battery packs are provided that include a multi-tiered battery system. An exemplary battery system may include a first battery cell matrix, a second battery cell matrix, and a first multi-tier end plate fastened to both the first battery cell matrix and the second battery cell matrix. The first multi-tier end plate is therefore shared between the first and second battery cell matrices to provide a space efficient design.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to traction battery packs with multi-tier cell stack assemblies that utilize end plates that are shared between upper and lower tiers.

### BACKGROUND

Electrified vehicles include a traction battery pack for powering electric machines and other electrical loads of the vehicle. The traction battery pack includes a plurality of battery cells and various other battery internal components that support electric vehicle propulsion. Some traction battery packs include cell stacks arranged in multiple tiers.

### SUMMARY

A traction battery pack according to an exemplary aspect of the present disclosure includes, among other things, a first battery cell matrix, a second battery cell matrix, and a first multi-tier end plate fastened to both the first battery cell matrix and the second battery cell matrix.

In a further non-limiting embodiment of the foregoing traction battery pack, a second multi-tier end plate is fastened to both the first battery cell matrix and the second battery cell matrix.

In a further non-limiting embodiment of either of the foregoing traction battery packs, the second multi-tier end plate is arranged at an opposite side of the first battery cell matrix and the second battery cell matrix from the first multi-tier end plate.

In a further non-limiting embodiment of any of the foregoing traction battery packs, the first battery cell matrix establishes a lower tier of a cell stack assembly, and the second battery cell matrix establishes an upper tier of the cell stack assembly.

In a further non-limiting embodiment of any of the foregoing traction battery packs, the cell stack assembly is fastened to an enclosure tray of an enclosure assembly of the traction battery pack.

In a further non-limiting embodiment of any of the foregoing traction battery packs, a first fastener is received through the first multi-tier end plate and into the first battery cell matrix.

In a further non-limiting embodiment of any of the foregoing traction battery packs, a second, first fastener is received through the first multi-tier end plate and into the second battery cell matrix.

In a further non-limiting embodiment of any of the foregoing traction battery packs, a second fastener is received through the first multi-tier end plate and into an enclosure assembly of the traction battery pack.

In a further non-limiting embodiment of any of the foregoing traction battery packs, a second, second fastener is received through a second multi-tier end plate and into the enclosure assembly.

In a further non-limiting embodiment of any of the foregoing traction battery packs, an adhesive is applied between the first multi-tier end plate and both the first battery cell matrix and the second battery cell matrix.

A traction battery pack according to another exemplary aspect of the present disclosure includes, among other things, a cell stack assembly including a first battery cell matrix, a second battery cell matrix arranged above the first battery cell matrix, a first multi-tier end plate, and a second multi-tier end plate. The first battery cell matrix and the second battery cell matrix are each arranged to extend between the first multi-tier end plate and the second multi-tier end plate.

In a further non-limiting embodiment of the foregoing traction battery pack, the first battery cell matrix establishes a lower tier of the cell stack assembly, and the second battery cell matrix establishes an upper tier of the cell stack assembly.

In a further non-limiting embodiment of either of the foregoing traction battery packs, the first multi-tier end plate and the second multi-tier end plate are each fastened to an enclosure tray of an enclosure assembly of the traction battery pack.

In a further non-limiting embodiment of any of the foregoing traction battery packs, the first multi-tier end plate and the second multi-tier end plate are each fastened to the enclosure tray by a plurality of fasteners.

In a further non-limiting embodiment of any of the foregoing traction battery packs, the first multi-tier end plate and the second multi-tier end plate are each fastened to the enclosure tray by an adhesive.

In a further non-limiting embodiment of any of the foregoing traction battery packs, the first multi-tier end plate and the second multi-tier end plate are fastened to both the first battery cell matrix and the second battery cell matrix by a plurality of fasteners.

In a further non-limiting embodiment of any of the foregoing traction battery packs, the first multi-tier end plate and the second multi-tier end plate are fastened to both the first battery cell matrix and the second battery cell matrix by an adhesive.

In a further non-limiting embodiment of any of the foregoing traction battery packs, the first multi-tier end plate and the second multi-tier end plate each include a first height that is equal to a sum of a second height of the first battery cell matrix, a third height of the second battery cell matrix, and a fourth height of a gap that extends between the first battery cell matrix and the second battery cell matrix.

In a further non-limiting embodiment of any of the foregoing traction battery packs, the second multi-tier end plate is arranged at an opposite side of the first battery cell matrix and the second battery cell matrix from the first multi-tier end plate.

A method for assembling a battery system of a traction battery pack according to another exemplary aspect of the present disclosure includes, among other things, fastening a first multi-tier end plate to a first battery cell matrix and a second battery cell matrix to construct a multi-tier cell stack assembly, and fastening the multi-tier cell stack assembly to an enclosure tray of the traction battery pack.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 illustrates a battery system of the traction battery pack of FIG. 2.

FIG. 4 illustrates another exemplary battery system of a traction battery pack.

FIG. 5 schematically illustrates an assembly method for assembling a battery system of a traction battery pack.

### DETAILED DESCRIPTION

This disclosure details traction battery packs that include a multi-tiered battery system. An exemplary battery system may include a first cell stack and a second cell stack, with each cell stack sharing a common end plate.

These and other features are discussed in greater detail in the following paragraphs of this detailed description.

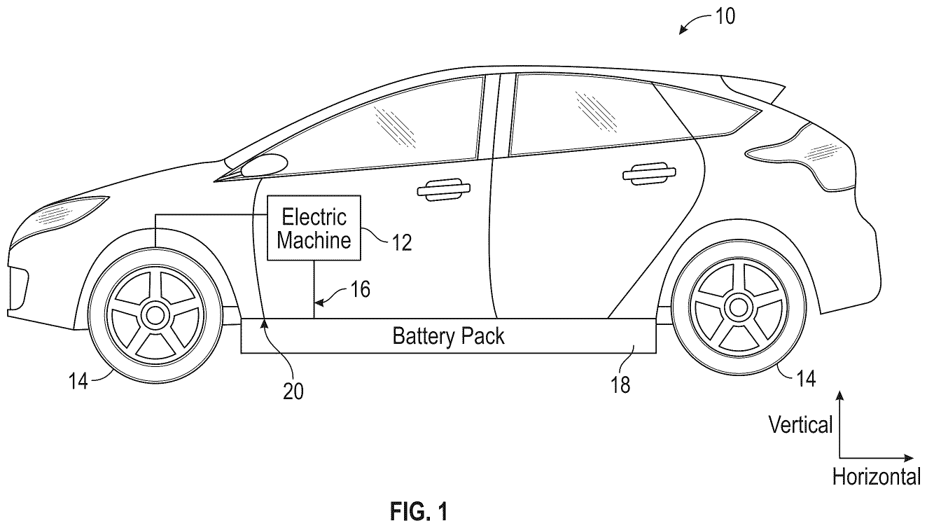

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

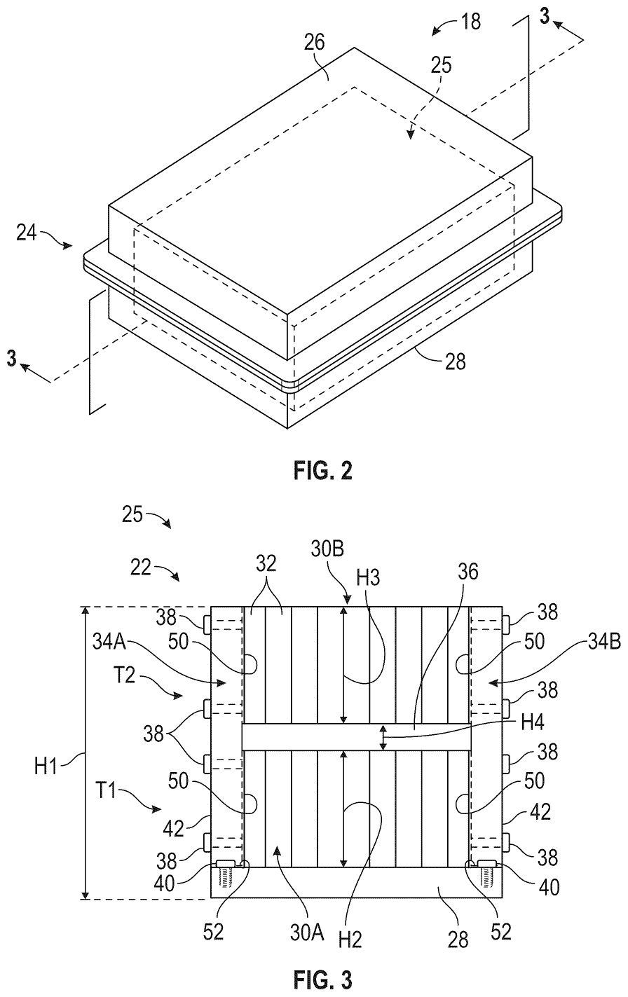

FIGS. 2 and 3 illustrate additional details associated with the traction battery pack 18 of the electrified vehicle 10 of FIG. 1. The traction battery pack 18 may include a battery system 25 housed within an interior area of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area for housing the battery system 25 and other battery internal components of the traction battery pack 18.

As best shown in FIG. 3, the battery system 25 may include one or more cell stack assemblies 22. Although a single cell stack assembly 22 is shown in FIG. 3, the battery system 25 could include a greater number of cell stack assemblies 22 within the scope of this disclosure. Each cell stack assembly 22 may be positioned atop the enclosure tray 28.

The cell stack assembly 22 includes a first or lower tier T1 and a second or upper tier T2 that is positioned vertically above the lower tier T1. Vertical and horizontal, for purposes of this disclosure, are with reference to ground and a general orientation of traction battery pack 18 when installed on the electrified vehicle 10 of FIG. 1.

The lower tier T1 of the cell stack assembly 22 may include a first battery cell matrix 30A, and the upper tier T2 of the cell stack assembly 22 may include a second battery cell matrix 30B. The cell stack assembly 22 is considered to be a multi-tiered cell stack assembly 22 because it includes battery cell matrices arranged within more than one tier.

Although the lower tier T1 and the upper tier T2 of the cell stack assembly 22 are each illustrated as including a single battery cell matrix 30, each tier could include greater than one battery cell matrix. Further, although two tiers are shown in the exemplary cell stack assembly 22, other examples could include more than two tiers.

The first battery cell matrix 30A and the second battery cell matrix 30B may each include a plurality of battery cells 32. The total number of battery cells 32 provided within each of the battery cell matrices 30A, 30B is not intended to limit this disclosure. In an embodiment, the battery cells 32 are lithium-ion prismatic cells. However, battery cells having other geometries (cylindrical, pouch, etc.) and/or chemistries (nickel-metal hydride, lead-acid, etc.) could alternatively be utilized within the scope of this disclosure.

The cell stack assembly 22 may additionally include one or more multi-tier end plates 34. In an embodiment, the cell stack assembly 22 includes a first multi-tier end plate 34A and a second multi-tier end plate 34B. The battery cells 32 of each battery cell matrix 30A, 30B may be stacked together and arranged between the first multi-tier end plate 34A and the second multi-tier end plate 34B. The first multi-tier end plate 34A and the second multi-tier end plate 34B are therefore positioned at opposite sides of the battery cell matrices 30A, 30B.

Each multi-tier end plate 34 may be a cast or extruded part made from a relatively rigid material, such as a metallic material, for example. However, the manufacturing technique utilized and the material make-up of the multi-tier end plates 34 are not intended to limit this disclosure.

Each of the first multi-tier end plate 34A and the second multi-tier end plate 34B may include a first height H1. The height H1 may be equal to a sum of a second height H2 of the first battery cell matrix 30A, a third height H3 of the second battery cell matrix 30B, and a fourth height H4 of a gap 36 (if any) that extends between the first battery cell matrix 30A and the second battery cell matrix 30B. Thus, rather than utilizing separate end plates for each battery cell matrix 30 of the cell stack assembly 22, the first battery cell matrix 30A and the second battery cell matrix 30B of the cell stack assembly 22 may utilize one or more shared or common multi-tier end plates 34. In the exemplary embodiment, each of the first height H1, the second height H2, the third height H3, and the fourth height H4 extends along a vertical or Z-axis of the traction battery pack 18.

The first multi-tier end plate 34A and the second multi-tier end plate 34B may each be secured (e.g., mechanically fastened) to both the first battery cell matrix 30A and the second battery cell matrix 30B. For example, a plurality of first fasteners 38 (e.g., bolts or screws) may be inserted through each of the first multi-tier end plate 34A and the second multi-tier end plate 34B and into the both the first battery cell matrix 30A and the second battery cell matrix 30B when assembling the cell stack assembly 22. An adhesive 50 may be alternatively or additionally be applied between the first and second multi-tier end plates 34A, 34B and each of the first and second battery cell matrices 30A, 30B. When mechanically secured in place, the multi-tier end plates 34 may therefore fasten the first battery cell matrix 30A and the second battery cell matrix 30B together.

In an embodiment, each first fastener 38 may be inserted through an outboard major side surface 42 of the first and second multi-tier end plates 34A, 34 (see FIG. 3). The first fasteners 38 may therefore each be inserted along an axis that is transverse (e.g., perpendicular) to the length of the first and second multi-tier end plates 34A.

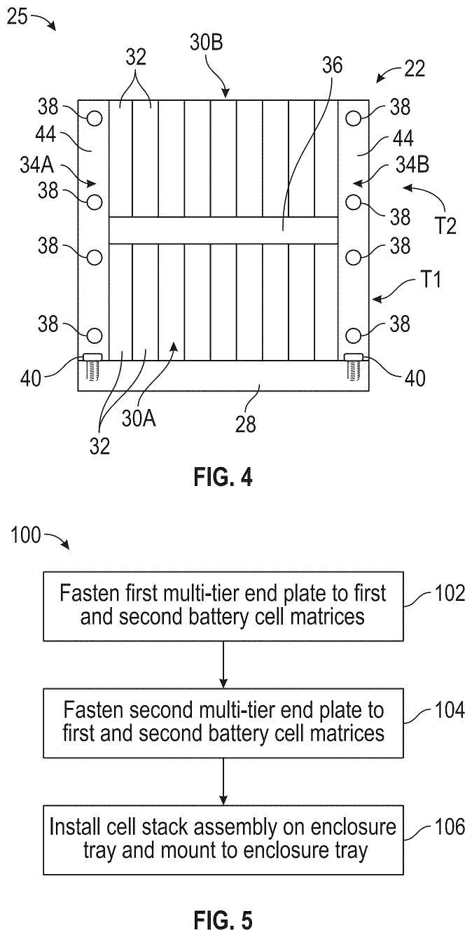

In another embodiment, each first fastener 38 may be inserted through an outboard minor side surface 44 of the first and second multi-tier end plates 34A, 34B (see FIG. 4). The first fasteners 38 may therebefore each be inserted along an axis that is parallel to the length of the first and second multi-tier end plate 34A, 34B.

The cell stack assembly 22 may be secured (e.g., mechanically fastened) directly to the enclosure tray 28 for structurally integrating the cell stack assembly 22 and the enclosure assembly 24 of the traction battery pack 18. For example, a plurality of second fasteners 40 (e.g., bolts or screws) may be inserted through each of the first multi-tier end plate 34A and the second multi-tier end plate 34B and then into the enclosure tray 28 for structurally integrating the cell stack assembly 22 to the enclosure assembly 24. The second fasteners 40 may each be inserted along an axis that is transverse (e.g., perpendicular) to an axis of insertion of the first fasteners 38. An adhesive 52 may be alternatively or additionally be applied between the first and second multi-tier end plates 34A, 34B and the enclosure tray 28 for fastening the cell stack assembly 22 to the enclosure tray 28.

FIG. 5, with continued reference to FIGS. 1-4, schematically illustrates an assembly method 100 for assembling the battery system 25 of the traction battery pack 18. The assembly method 100 may include a greater or fewer number of steps than those recited below. Notably, although not specifically shown, the first battery cell matrix 30A and the second battery cell matrix 30B may be held within an assembly fixture during portions of the assembly method 100.

At block 102, the first multi-tier end plate 34A may be fastened to the first battery cell matrix 30A and the second battery cell matrix 30B. The first fasteners 38 may be inserted through the first multi-tier end plate 34A and into the first battery cell matrix 30A and the second battery cell matrix 30B either sequentially or simultaneously for mounting the first multi-tier end plate 34A to both the first battery cell matrix 30A and the second battery cell matrix 30B. Alternatively or additionally, the first multi-tier end plate 34A may be adhesively fastened to the first battery cell matrix 30A and the second battery cell matrix 30B.

At block 104, the second multi-tier end plate 34B may be fastened to the first battery cell matrix 30A and the second battery cell matrix 30B. The first fasteners 38 may be inserted through second multi-tier end plate 34B and into the first battery cell matrix 30A and the second battery cell matrix 30B either sequentially or simultaneously for mounting the second multi-tier end plate 34B to both the first battery cell matrix 30A and the second battery cell matrix 30B. Alternatively or additionally, the second multi-tier end plate 34B may be adhesively fastened to the first battery cell matrix 30A and the second battery cell matrix 30B.

Notably, blocks 102 and 104 of the assembly method 100 could be performed either sequentially or simultaneously and at a single assembly station during the assembly method 100. The cell stack assembly 22 is considered assembled once both the first multi-tier end plate 34A and the second multi-tier end plate 34B are fastened to both the first battery cell matrix 30A and the second battery cell matrix 30B.

Next, at block 106, the cell stack assembly 22 may be installed on and mounted to the enclosure tray 28. The second fasteners 40 may be inserted through each of the first multi-tier end plate 34A and the second multi-tier end plate 34B for mounting the cell stack assembly 22 to the enclosure tray 28. The second fasteners 40 may be inserted through the first multi-tier end plate 34A and the second multi-tier end plate 34B either sequentially or simultaneously during block 106. Alternatively or additionally, the cell stack assembly 22 may be adhesively fastened to the enclosure tray 28.

The exemplary traction battery packs of this disclosure include a battery system incorporating one or more multi-tiered cell stack assemblies. Each cell stack assembly includes multi-tiered end plates that are shared between upper and lower cell matrices of the assembly, thereby providing a more space efficient design that requires less adhesive and/or fewer fasteners compared to prior designs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first battery cell matrix;
a second battery cell matrix; and
a first multi-tier end plate fastened to both the first battery cell matrix and the second battery cell matrix.

2. The traction battery pack as recited in claim 1, comprising a second multi-tier end plate fastened to both the first battery cell matrix and the second battery cell matrix.

3. The traction battery pack as recited in claim 2, wherein the second multi-tier end plate is arranged at an opposite side of the first battery cell matrix and the second battery cell matrix from the first multi-tier end plate.

4. The traction battery pack as recited in claim 1, wherein the first battery cell matrix establishes a lower tier of a cell stack assembly, and the second battery cell matrix establishes an upper tier of the cell stack assembly.

5. The traction battery pack as recited in claim 4, wherein the cell stack assembly is fastened to an enclosure tray of an enclosure assembly of the traction battery pack.

6. The traction battery pack as recited in claim 1, comprising a first fastener received through the first multi-tier end plate and into the first battery cell matrix.

7. The traction battery pack as recited in claim 6, comprising a second, first fastener received through the first multi-tier end plate and into the second battery cell matrix.

8. The traction battery pack as recited in claim 6, comprising a second fastener received through the first multi-tier end plate and into an enclosure assembly of the traction battery pack.

9. The traction battery pack as recited in claim 8, comprising a second, second fastener received through a second multi-tier end plate and into the enclosure assembly.

10. The traction battery pack as recited in claim 1, comprising an adhesive applied between the first multi-tier end plate and both the first battery cell matrix and the second battery cell matrix.

11. A traction battery pack, comprising:
a cell stack assembly including a first battery cell matrix, a second battery cell matrix arranged above the first battery cell matrix, a first multi-tier end plate, and a second multi-tier end plate,
wherein the first battery cell matrix and the second battery cell matrix are each arranged to extend between the first multi-tier end plate and the second multi-tier end plate.

12. The traction battery pack as recited in claim 11, wherein the first battery cell matrix establishes a lower tier of the cell stack assembly, and the second battery cell matrix establishes an upper tier of the cell stack assembly.

13. The traction battery pack as recited in claim 11, wherein the first multi-tier end plate and the second multi-tier end plate are each fastened to an enclosure tray of an enclosure assembly of the traction battery pack.

14. The traction battery pack as recited in claim 13, wherein the first multi-tier end plate and the second multi-tier end plate are each fastened to the enclosure tray by a plurality of fasteners.

15. The traction battery pack as recited in claim 13, wherein the first multi-tier end plate and the second multi-tier end plate are each fastened to the enclosure tray by an adhesive.

16. The traction battery pack as recited in claim 11, wherein the first multi-tier end plate and the second multi-tier end plate are fastened to both the first battery cell matrix and the second battery cell matrix by a plurality of fasteners.

17. The traction battery pack as recited in claim 11, wherein the first multi-tier end plate and the second multi-tier end plate are fastened to both the first battery cell matrix and the second battery cell matrix by an adhesive.

18. The traction battery pack as recited in claim 11, wherein the first multi-tier end plate and the second multi-tier end plate each include a first height that is equal to a sum of a second height of the first battery cell matrix, a third height of the second battery cell matrix, and a fourth height of a gap that extends between the first battery cell matrix and the second battery cell matrix.

19. The traction battery pack as recited in claim 11, wherein the second multi-tier end plate is arranged at an opposite side of the first battery cell matrix and the second battery cell matrix from the first multi-tier end plate.

20. A method for assembling a battery system of a traction battery pack, comprising:
fastening a first multi-tier end plate to a first battery cell matrix and a second battery cell matrix to construct a multi-tier cell stack assembly; and
fastening the multi-tier cell stack assembly to an enclosure tray of the traction battery pack.
